(19) United States
(12) Patent Application Publication
(10) Pub. No.: US 2026/0336514 A1
(43) Pub. Date: Oct. 29, 2026

(54) CUSTOMIZABLE DISPLAY SYSTEM

(71) Applicant: Fossign, LLC, Kennesaw, GA (US)

(72) Inventor: Kraig Kelly, Kennesaw, GA (US)

(73) Assignee: Fossign, LLC, Kennesaw, GA (US)

(21) Appl. No.: 19/191,267

(22) Filed: Apr. 28, 2025

(51) Int. Cl. B60Q 1/50; B60Q 1/26

(52) U.S. Cl. CPC B60Q 1/5035; B60Q 1/268; B60Q 1/2696

(57) ABSTRACT

A customizable display system for vehicles is disclosed. The system may include a first transparent plate, a second transparent plate, a custom message sheet and a lighting unit. The first transparent plate may have a first front surface and a first rear surface, and the second transparent plate may have a second front surface and a second rear surface. The second front surface may be magnetically attached to the first rear surface. The custom message sheet may be disposed between the first transparent plate and the second transparent plate. Further, the lighting unit may be disposed at the second rear surface. The lighting unit may illuminate the custom message sheet when the lighting unit is activated.

### TECHNICAL FIELD

The present disclosure relates to a customizable display system and more particularly to an illuminated customizable display system for vehicles.

### BACKGROUND

Many users customize their vehicles by adding aftermarket accessories, attaching or painting logos, messages, signs, sports memorabilia, etc. on the vehicle's body or windows, and/or the like. While the users customize their vehicles to enhance the vehicle's appearance according to the user's likes and preferences at a particular time, there are instances where the users may desire to remove or replace the vehicle's customization later. For example, a user may paste a message on the vehicle's body/window endorsing a particular political candidate during the election season, and may desire to remove this message when the election season is over. Further, in this case, the user may desire to replace this political message with a logo of the user's favorite football team when the football season starts.

Removing and/or replacing an attached or painted message, sign, etc. from the vehicle's body/window is a challenging task, which may require considerable manual effort. Further, in many cases, attempting to remove and/or replace such an attached or painted message, sign, etc. may damage the vehicle's body/window.

Therefore, there is a need for a system that may enable a user to conveniently and efficiently attach, remove and/or replace a message, sign, etc. from the vehicle's body/window.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a view of an example vehicle with a customizable display system in accordance with the present disclosure.

FIG. 2 depicts an exploded view of a first example customizable display system in accordance with the present disclosure.

FIG. 3 depicts a top view of a vehicle with a plurality of customizable display systems in accordance with the present disclosure.

FIG. 4 depicts an interior view of a vehicle with a plurality of second example customizable display systems in accordance with the present disclosure.

FIG. 5 depicts an exploded view of the second example customizable display system of FIG. 4 in accordance with the present disclosure.

### DETAILED DESCRIPTION

### Overview

The present disclosure describes a customizable display system (“system”) for a vehicle that may enable a vehicle user/owner to display custom messages, logos, signs, etc. on the vehicle's body or window. The message/content on the system may be customizable, removable and changeable, so that the user may replace the message/content as per the user's requirements or preferences at a particular time. For example, the user may display a message “Merry Christmas” on the system during the holiday season, and may replace this message with a name or logo of a particular political candidate that the user may be endorsing during the election season or a name, logo or flag of a football team that the user may be supporting during the football season.

In a first exemplary aspect, the system may include a first transparent plate, a second transparent plate and a custom message sheet (having a message/sign/logo printed on it) disposed between the first and second transparent plates. The first transparent plate may have adhesive patches on its front surface, which may enable the user to attach the first transparent plate to the vehicle window. Further, the first and second transparent plates may be magnetically connected to each other, so that the custom message sheet may be securely placed between the first and second transparent plates. The system may additionally include a lighting unit that may be disposed at a rear surface of the second transparent plate. The lighting unit may illuminate the custom message sheet when the lighting unit is activated (e.g., via the vehicle's power source or a system's in-built battery). In some aspects, the system may additionally include a diffuser sheet that may be disposed between the lighting unit and the second transparent plate's rear surface. The diffuser sheet may diffuse or “spread-out” the light emitted from the lighting unit so that the custom message sheet may be evenly illuminated.

In some aspects, to install the system described above on the vehicle window, the user may first attach the first transparent plate to the vehicle window via the adhesive patches. The user may then place/position the custom message sheet in proximity to the first transparent plate's rear surface and magnetically attach the first and second transparent plates to secure the custom message sheet between the first and second transparent plates. The user may then switch ON the lighting unit to illuminate the custom message sheet.

Further, to replace the custom message sheet with a new message sheet (containing a new message, sign, logo, etc.), the user may simply pull the second transparent plate away from the first transparent plate to decouple the magnetic attachment between these two plates. The user may then replace the custom message sheet with a new message sheet, and re-attach magnetically the first and second transparent plates. The user may then again switch ON the lighting unit to illuminate the new message sheet.

In a second exemplary aspect, the system may include an enclosure that may be cuboidal or cubicle in shape and may have a hollow interior portion, a transparent cover (“cover”) that covers the enclosure's front portion, a custom message sheet that may be adhered to the cover's rear surface that faces the enclosure's hollow interior portion or the cover's front surface, and a lighting unit that may be disposed in the enclosure's hollow interior portion. In this case, the system may further include a suction cup unit that enable the user to attach the enclosure to the vehicle window via one or more suction cups.

In this case, to install the system to the vehicle window, the user may first cover the enclosure's front portion with the cover (that contains the custom message sheet). The user may then place the enclosure on the vehicle window such that the cover's front surface (that faces away from the enclosure's hollow interior portion) tightly touches the vehicle window. The user may additionally use the suction cups to attach the enclosure to the vehicle window. The user may then switch ON or activate the lighting unit to illuminate the cover, thereby illuminating the custom message sheet that is adhered to the cover.

Further, in this case, to replace the cover with a new cover (containing a new message sheet), the user may “pull” the suction cups from the vehicle window to release the enclosure. The user may then replace the cover with the new cover on the enclosure, and then follow the same process described above to connect the enclosure with the new cover/message sheet to the vehicle window. In this manner, the user may easily replace an existing cover/message sheet with a new cover/message sheet.

The present disclosure discloses a customizable display system that may enable a user to conveniently replace a message, sign, logo, etc. that the user may have attached to the vehicle's body or window. The system enables the user to replace the custom message sheet without using any external tools, thereby considerably simplifying the process of replacing the message sheet. Further, due to the system's simple design, the user can replace the custom message sheet without potentially causing any damage to the vehicle's body or window.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

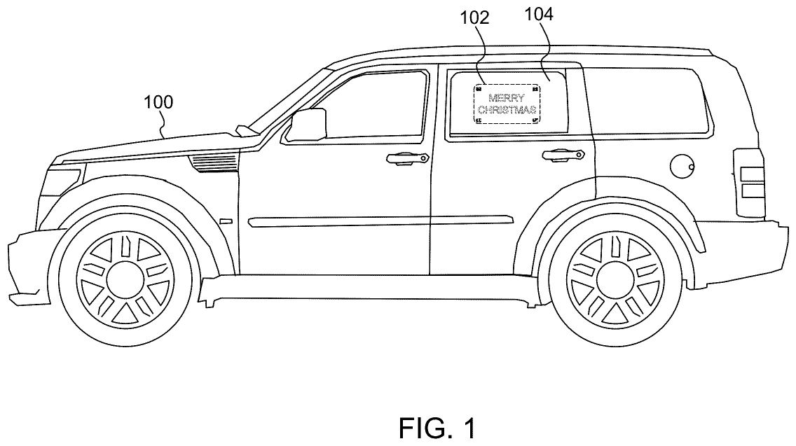

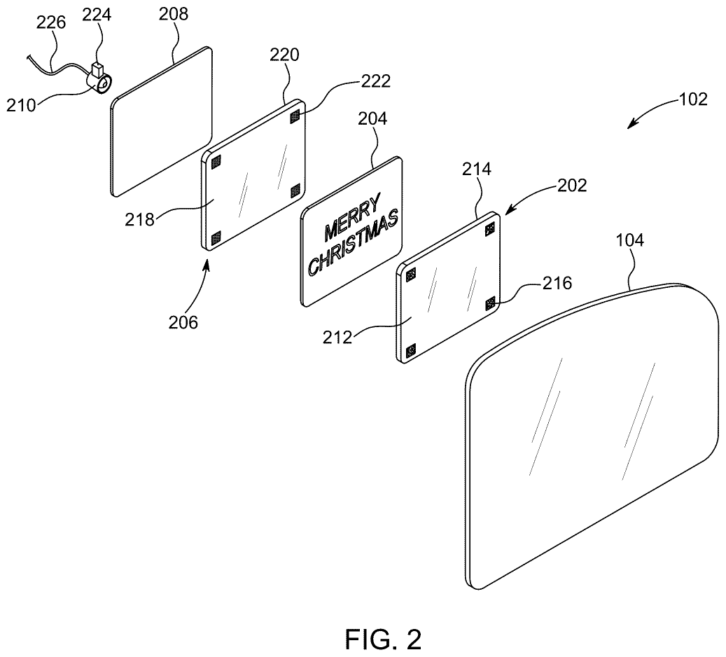

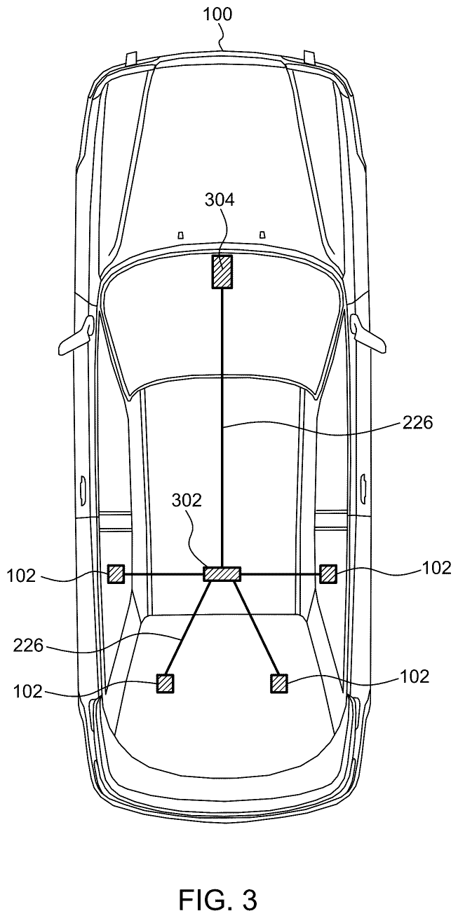

FIG. 1 depicts a view of an example vehicle 100 with a customizable display system 102 (or system 102) in accordance with the present disclosure. FIG. 1 will be described in conjunction with FIGS. 2 and 3.

The vehicle 100 may be any passenger or commercial vehicle such as a car, a work vehicle, a crossover vehicle, a truck, a van, a minivan, a taxi, a bus, etc. The vehicle 100 may be a manually driven vehicle or may be configured to operate in a partially/fully autonomous mode. Further, the vehicle 100 may include any powertrain, such as a gasoline engine, one or more electrically-actuated motor(s), or a hybrid system.

The system 102 may be an illuminated customizable display system that may enable the vehicle owner/user to display custom messages, logos, signs, etc. on the vehicle's body or window 104, as depicted in FIG. 1. The message/content on the system 102 may be customizable, removable and changeable, so that the user may replace the message/content as per the user's requirements or preferences at a particular time. For example, the user may display a message “Merry Christmas” on the system 102 during the holiday season, and may replace this message with a name or logo of a particular political candidate that the user may be endorsing during the election season or a name, logo or flag of a football team that the user may be supporting during the football season.

The system 102 may include a plurality of components including, but not limited to, a first transparent plate 202 (as shown in FIG. 2), a custom message sheet 204, a second transparent plate 206, a diffuser sheet 208, a lighting unit 210, and/or the like. The first and second transparent plates 202, 206 may have equivalent dimensions and may be made of same or similar material. For example, the first and second transparent plates 202, 206 may be made of transparent plastic or acrylic, and may be rectangular or square with dimensions of the edges in a range of 4-12 inches. The message sheet 204 may be thin (e.g., having thickness in millimeters) and may be made of translucent paper, fabric, plastic, and/or the like. In an exemplary aspect, the message sheet 204 may have the same shape and equivalent dimensions as the shape and dimensions of the first and second transparent plates 202, 206. In some aspects, the message sheet 204 may be made of a transparent static window cling material. This aids in both the illumination and easy removal/positioning of the message sheet 204.

The first transparent plate 202 may include a first front surface 212 and a first rear surface 214. In an exemplary aspect, one or more first attachment members 216 (that may be part of the system 102) may be disposed on the first front surface 212, as shown in FIG. 2. The first attachment member(s) 216 may be adhesives or adhesive patches that may be disposed on the four corners of the first front surface 212 or may be an adhesive tape that may be disposed on one or more edges of the first front surface 212 (or on any other location on the first front surface 212). The first attachment member(s) 216 may enable the user to attach the first front surface 212 to an external surface, e.g., the vehicle window 104. Specifically, the user may attach the first front surface 212 to the vehicle window 104 via the first attachment member(s) 216 when the user desires to adhere/connect the system 102 to the window 104.

The second transparent plate 206 may include a second front surface 218 and a second rear surface 220. In an exemplary aspect, one or more second attachment members 222 (that may be part of the system 102) may be disposed on the second front surface 218 and the first rear surface 214. In some aspects, the second attachment members 222 may be magnetic and ferrous attachment members (e.g., magnets and iron pieces, or magnets of opposite polarities) that may enable the user to magnetically attach the second front surface 218 to the first rear surface 214. In an exemplary aspect, the second attachment members 222 may be disposed on the four corners of the second front surface 218 and the first rear surface 214, or may be in a form of a magnetic tape or portion that may be present on the edges or any other portion of the second front surface 218 and the first rear surface 214.

The message sheet 204 may be disposed between the first transparent plate 202 and the second transparent plate 206. Specifically, after attaching the first front surface 212 to the vehicle window 104 via the first attachment member(s) 216, the user may position the message sheet 204 at the first rear surface 214 (with the surface of the message sheet 204 that contains the printed message facing the first rear surface 214) and then magnetically attach the first transparent plate 202 and the second transparent plate 206 (or the second front surface 218 with the first rear surface 214) via the second attachment members 222. The message sheet 204 stays securely placed between the first and second transparent plates 202, 206, when these two plates get magnetically coupled. Additionally, since the message sheet 204 is made of a static cling material, the material assists in keeping it securely placed between the first and second transparent plates 202 and 206. Since the first and second transparent plates 202, 206 and the vehicle window 104 are transparent, the surface of the message sheet 204 that contains the printed message is visible from outside the vehicle 100 when the message sheet 204 is secured between the first and second transparent plates 202, 206 as described above.

The lighting unit 210 may include one or more light emitting diodes (LEDs) or an LED array, and may be disposed at the second rear surface 220. In an exemplary aspect, the lighting unit 210 may be disposed at a center portion of the second rear surface 220. The lighting unit 210 may illuminate the message sheet 204 when the lighting unit 210 is activated, thereby enhancing the message sheet's visibility and aesthetic appeal (specifically, the visibility and aesthetic appeal of the message, sign, logo, etc. printed on the message sheet 204) to the viewers outside the vehicle 100.

In some aspects, the lighting unit 210 or the system 102 may include a battery 224 that may supply power to the lighting unit 210 to enable the LED's illumination. The lighting unit 210 may include or be electrically connected with an ON/OFF switch or button (not shown in FIG. 2), which can be used by the user to switch ON or OFF the lighting unit 210. When the user switches ON the button, the battery 224 may supply power to the lighting unit 210 to enable the LED's illumination.

In additional or alternative aspects, the system 102 may include a Universal Serial Bus hub 302 (or USB hub 302, shown in FIG. 3) that may be connected to the lighting unit 210 via a USB cable 226. The USB hub 302 may transfer power from an external power source (e.g., a vehicle battery or power source 304) to the lighting unit 210 via the USB cable 226, to enable the LED's illumination. In some aspects, the same USB hub 302 may transfer power from the vehicle power source 304 to multiple systems 102 simultaneously (as shown in FIG. 3), to enable their operation. In this case, multiple systems 102 may be located at different locations on the vehicle 100, and may draw power from the vehicle power source 304 via the USB hub 302.

In the example aspect described above, the USB cable 226 may be removably connected to the lighting unit 210, so that the USB cable 226 may be removed from the lighting unit 210 when required. As an example, if the system 102 is installed on a vehicle door's window, there may be instances where the user may desire to remove the USB cable 226 from the lighting unit 210, e.g., when the user desires to open the door. It may be appreciated that if the door is opened when the USB cable 226 is still connected to the lighting unit 210, the USB cable 226 may get stretched or pulled, which may damage the USB cable 226 and/or the system 102. To prevent such a scenario from occurring, the user may first remove the USB cable 226 from the lighting unit 210, and then open the door.

In some aspects, the diffuser sheet 208 may be disposed between the lighting unit 210 and the second rear surface 220. The diffuser sheet 208 may diffuse or “spread-out” the light emitted from the lighting unit 210 so that the light evenly illuminates the entire surface of the message sheet 204 (and the illumination is not localized to only that message sheet's area/surface that is closest to the LEDs).

During operation, the user may first attach the first transparent plate 202 to the vehicle window 104 via the first attachment member(s) 216, when the user desires to install the system 102 on the vehicle 100. The user may then place/position the message sheet 204 in proximity to the first rear surface 214 and magnetically attach the second front surface 218 with the first rear surface 214 to secure the message sheet 204 between the first and second transparent plates 202, 206. The user may then switch ON the lighting unit 210 (that may be disposed at the second rear surface 220, as described above) to illuminate the message sheet 204.

To replace the message sheet 204 with a new message sheet (containing a new message, sign, logo, etc.), the user may simply pull the second front surface 218 away from the first rear surface 214 to decouple the magnetic attachment between these two surfaces. The user may then replace the message sheet 204 with a new message sheet, and re-attach magnetically the second front surface 218 with the first rear surface 214. In this manner, the user may conveniently replace an existing message sheet with a new message sheet as per the user's requirement or preferences at a particular time. For example, the user may replace a “political” message sheet with a football message sheet, when the election season gets over and the football season begins.

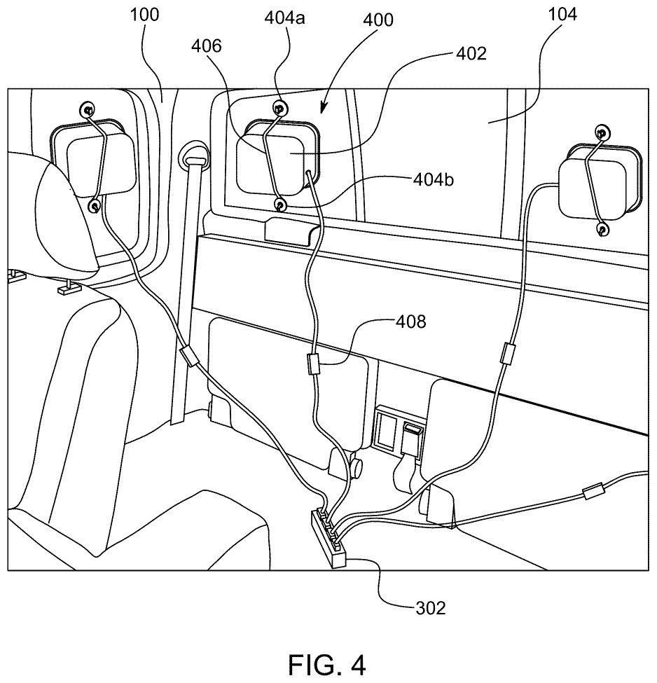

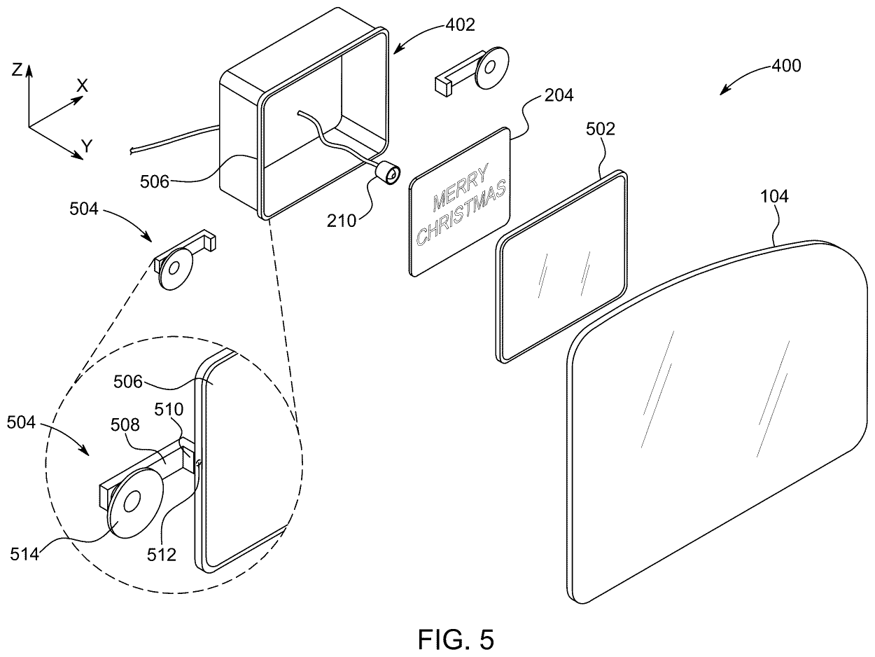

FIG. 4 depicts an interior view of the vehicle 100 with a plurality of second example customizable display systems 400 (or system 400) in accordance with the present disclosure. FIG. 4 will be described in conjunction with FIG. 5.

The system 400 may be similar in function to the system 102 described above; however, the system 400 may have a different structure and/or components than the structure and/or components of the system 102. In some aspects, the system 400 may include an enclosure 402 that may be cuboidal or cubicle in shape and may have a hollow interior portion, a transparent cover 502 (shown in FIG. 5) that covers a front portion of the enclosure 402 (“enclosure's front portion”), the message sheet 204 that may be adhered to a rear surface of the cover 502 that faces the enclosure's hollow interior portion (or to the cover's front surface between the vehicle window 104 and the cover 502, in some embodiments), and the lighting unit 210 that may be disposed in the enclosure's hollow interior portion.

In one exemplary aspect, the system 400 may include two or more suction cups 404a, 404b that may be adhered to the vehicle window 104. To attach the system 400 to the vehicle window 104, the user may first cover the enclosure's front portion with the cover 502 (that contains the message sheet 204). The user may then place the enclosure 402 on the vehicle window 104 such that the cover's front surface (that faces away from the enclosure's hollow interior portion) tightly touches the vehicle window 104. The user may additionally attach the suction cups 404a, 404b on the vehicle window 104 and connect a rubber band or tape 406 to the suction cups 404a, 404b, such that the rubber tape 406 wraps around the enclosure's exterior surface (as shown in FIG. 4), thereby securely connecting or placing the enclosure 402 on the vehicle window 104. The user may then switch ON or activate the lighting unit 210 (e.g., via a switch ON/OFF button 408) to illuminate the cover 502, thereby illuminating the message sheet 204 that is adhered to the cover's rear surface.

In some aspects, the lighting unit 210 may be placed in the enclosure's hollow interior portion and connected to the enclosure's back wall (that is opposite to the cover 502). In this case, the lighting unit 210 may directly transmit light towards the cover 502, thereby illuminating the message sheet 204. In other aspects, the lighting unit 210 may be connected to an interior surface of one or more sidewalls of the enclosure 402. In this case, the lighting unit 210 may transmit light parallel to the plane of the cover 502 (e.g., X-Z plane), so that the cover 502 (and hence the message sheet 204) is evenly illuminated. In further aspects, the system 400 may include a diffuser sheet (similar to the diffuser sheet 208 described above) that may be placed between the lighting unit 210 and the cover 502, which may diffuse or spread-out the light emitted by the lighting unit 210 to evenly illuminate the message sheet 204/cover 502.

In another exemplary aspect, the system 400 may include one or more suction cup units 504 that may be pivotally or rotatably connected to an edge 506 of a sidewall of the enclosure 402 (as shown in FIG. 5). The suction cup unit 504 may rotate relative to a plane of the enclosure's sidewall (e.g., Y-Z plane), and may enable the user to attach or detach the enclosure 402 to or from the vehicle window 104.

In an exemplary aspect, each suction cup unit 504 may include an L-shaped bracket having a first wall 508 and a second wall 510, which may be connected to each other and be perpendicular to each other, as shown in FIG. 5. An edge of the second wall 510 (that faces away from the first wall 508) may be connected to the edge 506 of the enclosure's sidewall via one or more hinge connectors 512, which may enable the L-shaped bracket to rotate about the edge 506 (and hence relative to the enclosure sidewall's plane).

Each suction cup unit 504 may further include a suction cup 514 (which may be similar to the suction cup 404a, 404b described above) that may be attached to the first wall 508.

The L-shaped bracket may rotate between a first position and a second position via the hinge connectors 512. A plane of the suction cup 514 or the first wall 508 may be perpendicular to the enclosure sidewall's plane (e.g., Y-Z plane) when the L-shaped bracket is in the first position. As may be appreciated, when the enclosure 402 is placed on the vehicle window 104 such that the cover 502 faces or touches the window 104, the enclosure sidewall's plane (e.g., Y-Z plane) may be perpendicular to the window's plane. Therefore, when the L-shaped bracket is in the first position, the plane of the suction cup 514 or the first wall 508 is parallel to the vehicle window 104. In this position, the user may push the first wall 508 or the suction cup 514 towards the vehicle window 104 to enable the suction cup 514 (and hence the enclosure 402/system 400) to attach to the vehicle window 104. Therefore, the suction cup 514 may enable the user to attach the enclosure 402 to the vehicle window 104 when the L-shaped bracket is in the first position.

The plane of the suction cup 514 or the first wall 508 may be parallel to the enclosure sidewall's plane (and hence perpendicular to the vehicle window's plane) when the L-shaped bracket is in the second position. Therefore, when the user desires to remove the suction cup 514 (and hence the enclosure 402) from the vehicle window 104, the user may rotate the L-shaped bracket from the first position (at which the suction cup 514 is attached to the vehicle window 104) to the second position (at which the suction cup 514 is detached from the vehicle window 104).

During operation, the user may first cover or close the enclosure's front surface with the cover 502 (that may have the message sheet 204 adhered to it). The user may then rotate the L-shaped bracket to the first position (at which the plane of the suction cup 514 is parallel to the vehicle window's plane), and push the suction cup 514 onto the vehicle window 104 to attach the suction cup 514 (and hence the enclosure 402) to the vehicle window 104. The user may then activate the lighting unit 210 (e.g., via the ON/OFF button 408) to illuminate the message sheet 204 adhered to the cover 502. In this manner, the user may install and operate the system 400.

When the user desires to replace the cover 502 with a new cover (containing a new message sheet), the user may “pull” the suction cup 514 from the vehicle window 104 and rotate the L-shaped bracket to the second position. This may cause the enclosure 402 to get removed from the vehicle window 104. The user may then replace the cover 502 with the new cover on the enclosure 402, and then follow the same process described above to connect the enclosure 402 (and hence the system 400) with the new cover/message sheet to the vehicle window 104. In this manner, the user may easily replace an existing cover/message sheet with a new cover/message sheet.

In alternative aspects (not shown), instead of the message sheet 204 being adhered to the cover 502, the cover 502 may be a digital screen that may display different types of messages/signs/logos. In this case, the system 400 may include a processor, a memory and a transceiver, which may be communicatively coupled (e.g., via Bluetooth) with a user device (e.g., a vehicle owner's mobile phone, smartwatch, laptop, computer, etc.) and receive command signals from the user device. Based on the obtained command signals, the processor may automatically display a message, logo, sign, etc. on the cover's digital screen as per the user's requirements / preferences. In this case, the memory may store a plurality of preset messages, logos, signs, etc., and the user may command the processor to display any one of these preset messages/logos/signs on the cover's display screen by transmitting the command signal from the user device to the system 400.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation. Further, it is to be noted that various embodiments of the present disclosure may utilize elements and/or components other than those illustrated in the drawings, and some elements and/or components may not be present in various embodiments. Furthermore, the components may have various shapes, and the present disclosure is not limited to the shapes depicted in the drawings.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A system comprising:
a first transparent plate having a first front surface and a first rear surface;
a second transparent plate having a second front surface and a second rear surface, wherein the second front surface is magnetically attached to the first rear surface;
a custom message sheet disposed between the first transparent plate and the second transparent plate;
a lighting unit disposed at the second rear surface, wherein the lighting unit is configured to illuminate the custom message sheet when the lighting unit is activated; and
a diffuser sheet disposed between the lighting unit and the second transparent plate, wherein the diffuser sheet is configured to diffuse light emitted from the lighting unit, and wherein the diffuser sheet is disposed in a plane parallel to the custom message sheet and illumination from the lighting unit is directed normal to a plane of the diffuser sheet.

2. The system of claim 1 further comprising one or more first attachment members disposed on the first front surface, wherein the one or more first attachment members enable the first front surface to attach to an external surface.

3. The system of claim 2, wherein the one or more first attachment members are adhesives that enable the first front surface of the first transparent plate to attach to the external surface.

4. The system of claim 1 further comprising one or more second attachment members disposed on the second front surface and the first rear surface, wherein the one or more second attachment members enable the second front surface to attach to the first rear surface.

5. The system of claim 4, wherein the one or more second attachment members are magnetic and ferrous attachment members.

6. (canceled)

7. The system of claim 1, wherein the lighting unit comprises one or more light emitting diodes (LEDs).

8. The system of claim 1 further comprising a battery configured to supply power to the lighting unit.

9. The system of claim 1 further comprising a Universal Serial Bus (USB) port connected to the lighting unit, wherein the USB port is configured to transfer power from an external power source to the lighting unit.

10. A system comprising:
a first transparent plate having a first front surface and a first rear surface;
one or more first attachment members disposed on the first front surface, wherein the one or more first attachment members enable the first front surface to attach to an external surface, and wherein the one or more first attachment members are adhesives that enable the first front surface of the first transparent plate to attach to the external surface;
a second transparent plate having a second front surface and a second rear surface, wherein the second front surface is magnetically attached to the first rear surface;
a custom message sheet disposed between the first transparent plate and the second transparent plate;
a lighting unit disposed at the second rear surface, wherein the lighting unit is configured to illuminate the custom message sheet when the lighting unit is activated; and
a diffuser sheet disposed between the lighting unit and the second rear surface of the second transparent plate, wherein the diffuser sheet is configured to diffuse light emitted from the lighting unit, and wherein the diffuser sheet is disposed in a plane parallel to the custom message sheet and illumination from the lighting unit is directed normal to a plane of the diffuser sheet.

11. (canceled)

12. The system of claim 10 further comprising one or more second attachment members disposed on the second front surface and the first rear surface, wherein the one or more second attachment members enable the second front surface to attach to the first rear surface.

13. The system of claim 12, wherein the one or more second attachment members are magnetic and ferrous attachment members.

14. The system of claim 10, wherein the lighting unit comprises one or more light emitting diodes (LEDs).

15. The system of claim 10 further comprising a battery configured to supply power to the lighting unit.

16. The system of claim 10 further comprising a Universal Serial Bus (USB) port connected to the lighting unit, wherein the USB port is configured to transfer power from an external power source to the lighting unit.

17. A system comprising:
an enclosure having a hollow interior portion;
a transparent cover configured to cover a front portion of the enclosure;
a custom message sheet adhered to the transparent cover;
a lighting unit disposed in the hollow interior portion, wherein the lighting unit is configured to illuminate the custom message sheet when the lighting unit is activated; and
a suction cup unit pivotally connected to an edge of a sidewall of the enclosure, wherein:
the suction cup unit is configured to rotate relative to a plane of the sidewall,
the suction cup unit is configured to enable the enclosure to attach to an external surface,
the suction cup unit comprises an L-shaped bracket and a suction cup attached to the L-shaped bracket.
the L-shaped bracket is pivotally connected to the edge of the sidewall via a hinge connector and configured to rotate between a first position and a second position, and
the suction cup is configured to enable the enclosure to attach to the external surface when the L-shaped bracket is in the first position.

18. (canceled)

19. The system of claim 17, wherein a plane of the suction cup is perpendicular to the plane of the sidewall when the L-shaped bracket is in the first position, wherein the plane of the suction cup is parallel to the plane of the sidewall when the L-shaped bracket is in the second position.

20. The system of claim 17, wherein the lighting unit is connected to an interior surface of the sidewall of the enclosure.
